(19) United States
(12) Patent Application Publication
(10) Pub. No.: US 2009/0272733 A1
(43) Pub. Date: Nov. 5, 2009

(54) Heating and Melting of Multiple Discrete Charges in an Electric Induction Furnace

(76) Inventor: John H. MORTIMER, Little Egg Harbor Township, NJ (US)

Correspondence Address: PHILIP O. POST;INDEL, INC., PO BOX 157, RANCOCAS, NJ, 08073, US

(21) Appl. No.: 12/432,469

(22) Filed: Apr. 29, 2009

Related U.S. Application Data
(60) Provisional application No. 61/049,179, filed on Apr. 30, 2008.

(51) Int. Cl. H05B 6/10

(52) U.S. Cl. 219/635

(57) ABSTRACT

Multiple discrete charges of an electrically conductive material, such as pencil ingots, are inductively heated or melted in an electric induction furnace. The multiple discrete metal charges are electrically connected together during the induction heating or melting process. One method of making this electrical connection is to immerse the ends of the multiple discrete metal charges in a volume of molten metal during the induction heating and melting process.

### CROSS REFERENCE TO RELATED APPLICATIONS

This application claims the benefit of U.S. Provisional Application No. 61/049,179, filed Apr. 30, 2008, hereby incorporated by reference in its entirety.

### FIELD OF THE INVENTION

The present invention relates to electric induction heating and melting of charge in an induction furnace, particularly when the charge comprises multiple discrete charges that are electrically isolated from each other.

### BACKGROUND OF THE INVENTION

One type of charge that can be heated and melted in an electric induction furnace is known as a pencil (shaped) ingot. The name derives from the elongated cylindrical shape of the charge, which geometrically resembles a graphite stick used in a pencil.

FIG. 1 diagrammatically illustrates a singular pencil ingot 190 placed within coreless induction furnace 110 comprising crucible 112 surrounded by at least one induction coil 114 suitably connected to at least one alternating current (AC) power source 116. When AC current flows through the induction coil, an electromagnetic field is generated that penetrates the crucible and magnetically couples with the singular pencil ingot in the crucible. The magnetic coupling induces eddy current in the ingot to inductively melt the ingot. Magnetic coupling with a singular pencil ingot is very poor. Adjustment of the operating parameters of the power source or physical characteristics of the induction coil and/or the crucible to optimize flux coupling with the ingot is generally limited due to process requirements.

Multiple discrete pencil ingots 190a, 190b, 190c and 190d may be used as shown in FIG. 2 to improve operating power efficiency. However the AC current induced in each ingot (instantaneous current direction illustrated by arrows in FIG. 2) generates a magnetic flux that opposes and cancels the magnetic flux generated in the other ingots, thereby substantially reducing the advantage in using multiple pencil ingots. FIG. 3 graphically illustrates a typical “melting versus time” process curve that is achievable with the arrangement shown in FIG. 2 wherein substantially all (100%) of the discrete pencil ingots 190a, 190b, 190c and 190d are completely melted at time T₁.

It is one object of the present invention to substantially decrease the amount of time required to inductively melt multiple discrete charges, such as pencil-shaped ingots.

It is another object of the present invention to improve the power efficiency of the electric induction heating and melting process for multiple discrete charges.

### BRIEF SUMMARY OF THE INVENTION

In one aspect the present invention is apparatus for, and method of, inductively heating and melting multiple discrete charges. The multiple discrete charges are placed in a crucible surrounded by one or more induction coils connected to an AC power source. An electrically conductive path is established between all of the multiple discrete charges at the beginning of the induction heating or melting process. The electrically conductive path may be established by surrounding the lower ends of the multiple discrete charges in the crucible with electrically conductive molten metal. The multiple discrete charges may be pencil-shaped ingots.

The above and other aspects of the invention are set forth in this specification and appended claims.

### BRIEF DESCRIPTION OF THE DRAWINGS

The foregoing brief summary, as well as the following detailed description of the invention, is better understood when read in conjunction with the appended drawings. For the purpose of illustrating the invention, there is shown in the drawings exemplary forms of the invention that are presently preferred; however, the invention is not limited to the specific arrangements and instrumentalities disclosed in the following appended drawings:

FIG. 1 is a simplified isometric view of a singular discrete charge placed within a crucible surrounded by an induction coil.

FIG. 2 is a simplified isometric view of multiple discrete charges placed within a crucible surrounded by an induction coil.

FIG. 3 is a typical “melt versus time” process performance curve for the electric induction heating and melting arrangement shown in FIG. 2.

FIG. 4 is a simplified isometric view of one diagrammatic arrangement of the electric induction heating or melting process of the present invention.

FIG. 5 is a typical “melt versus time” process performance curve for the electric induction heating and melting arrangement shown in FIG. 4.

FIG. 6 is a simplified cross sectional elevation view of one example of an electric induction furnace in which the process of the present invention may be performed.

FIG. 7(a) is a cross sectional elevation view of one example of an electric induction furnace of the present invention for heating or melting multiple discrete charges.

FIG. 7(b) is a cross sectional plan view through line A-A of the electric induction furnace in FIG. 7(a).

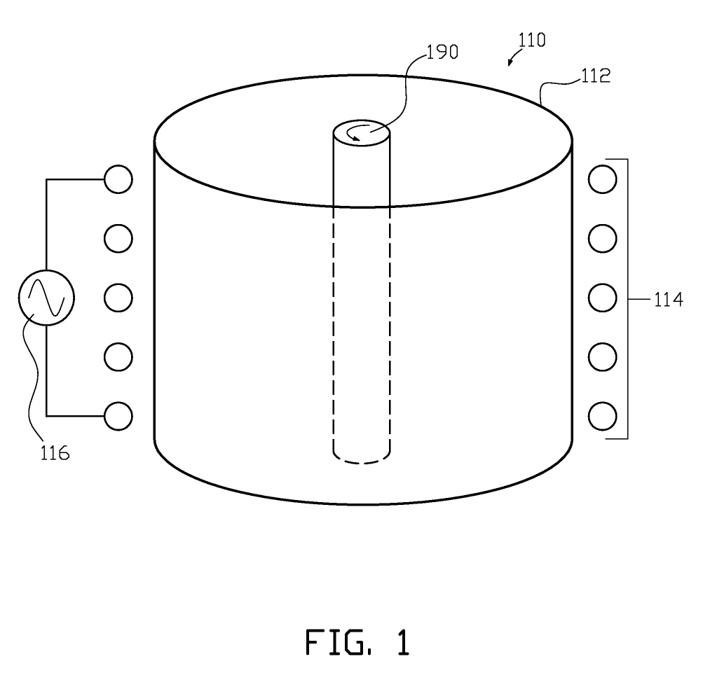

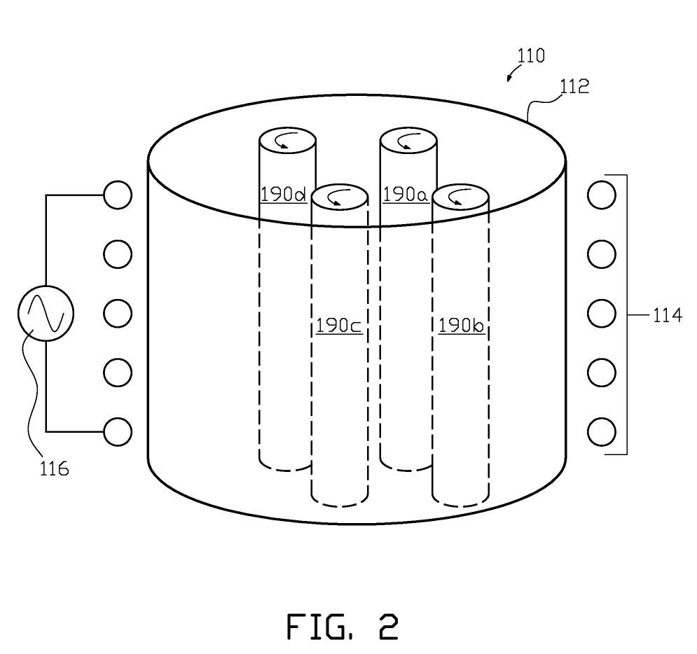

### DETAILED DESCRIPTION OF THE INVENTION

While the below examples of the invention use the term “pencil ingot,” more generally the invention is applicable to other shapes of discrete charges that are inductively heated or melted at the same time in an electric induction furnace.

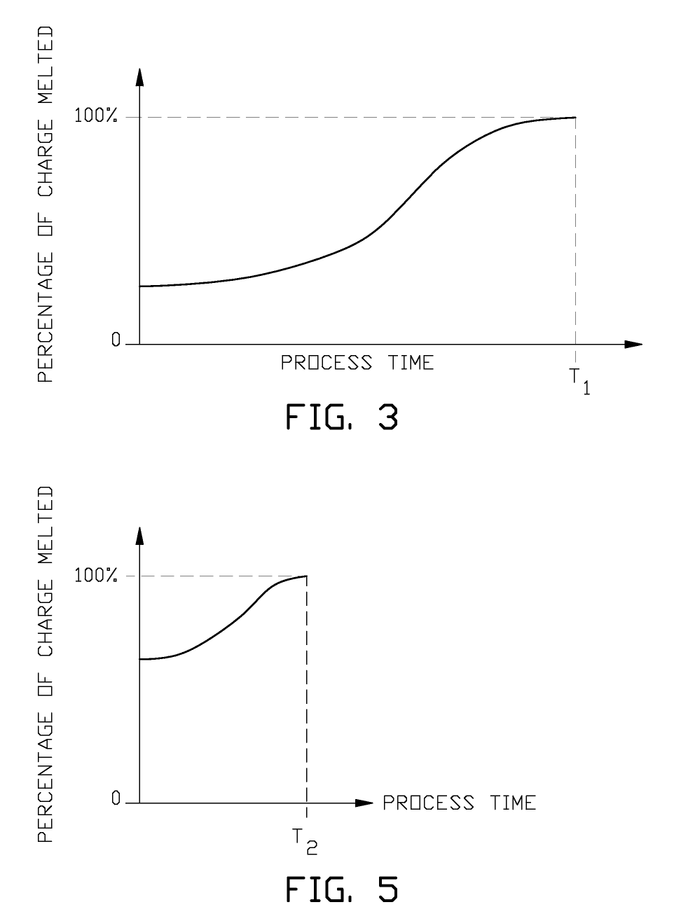

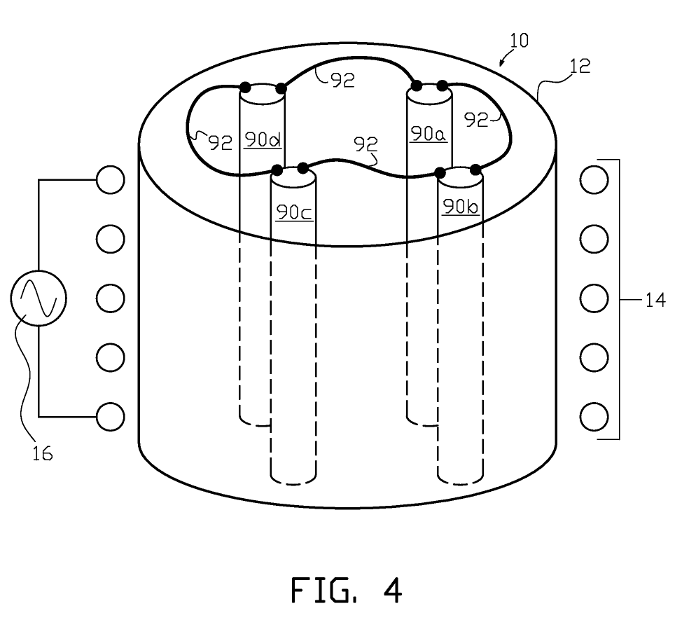

FIG. 4 illustrates diagrammatically one example of the present invention. Electric induction furnace 10 comprises crucible 12 and at least one induction coil 14 surrounding the exterior of the crucible. Induction coil 14 is connected to at least one source 16 of AC current. Pencil ingots 90a, 90b, 90c and 90d are placed in the crucible for an induction heating or melting process. A suitable electrically conductive path is established between all pencil ingots placed in the crucible. For example as shown in FIG. 4 the electrically conductive path between pencil ingots is diagrammatically represented by lines 92. The closed loop electrical circuit thus achieved between the pencil ingots links most of the magnetic flux thereby reducing flux leakage and increasing the induction melting efficiency and power draw from source 16. FIG. 5 graphically illustrates a typical “melting versus time” process curve that is achievable with the arrangement shown in FIG. 4 wherein substantially all (100%) of the four discrete pencil ingots are completely melted at time T₂. Induction melting process time T₂ is substantially shorter than induction melting process time T₁ shown in FIG. 3 for the equivalent prior art process without establishing a suitable electrical path between all pencil ingots. Subsequent to melting the pencil ingots, the resulting molten material may be removed from the furnace in conventional fashion, such as but not limiting to, tilt pour, bottom pour or pressure pour.

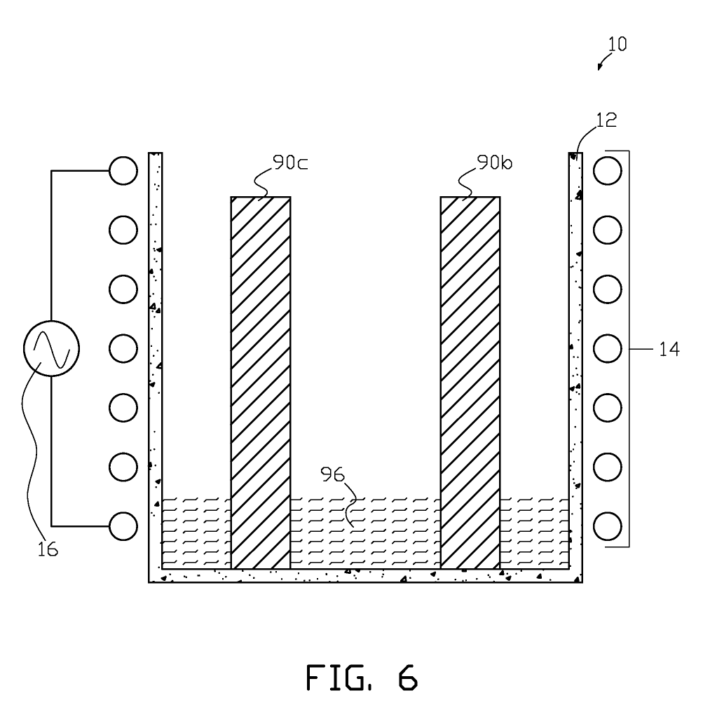

An alternative method of establishing an electrically conductive path between the pencil ingots is illustrated in FIG. 6. In this arrangement a heel of electrically conductive material 96 (for example, molten ingot material) is kept in the crucible after pouring molten ingot material from the crucible, and before new pencil ingots are placed in the crucible for melting. Alternatively, suitable electrically conductive material 96 may be poured into the crucible after the new pencil ingots are placed in the crucible without heel. As the induction melting process begins, the molten metal further heats and penetrates into portions of the pencil ingots that sit in the molten metal thus providing a high level of electrical conductivity between the ingots.

The volume of molten metal must establish a sufficient contact area to provide an electrical path for current that can be in the range of hundreds or thousands of amperes. One non-limiting example of the invention is to immerse at least 10 percent of the length of the pencil ingots in molten metal to establish sufficient electrically conductive contact area.

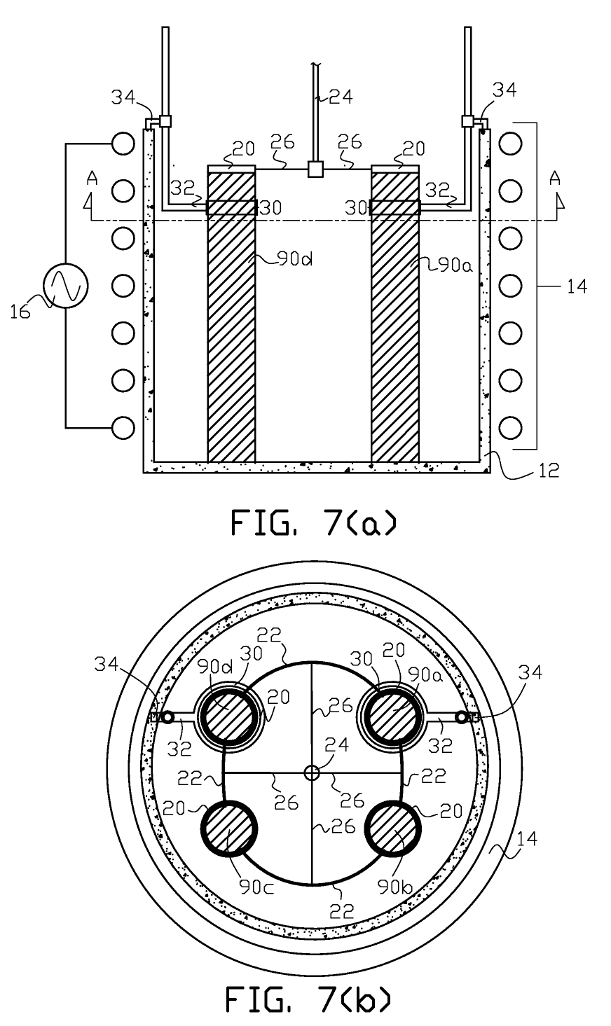

In other examples of the invention the electrically conductive path between pencil ingots may be achieved by an electrically conductive form that at least partially surrounds, and is in contact with, the ingots, and can be raised or lowered around the ingots as the ingot melting process progresses. For example as shown in FIG. 7(a) and FIG. 7(b) electrically conductive annular elements 20 can be positioned around the top or outer diameter of each solid pencil ingot. Electrically conductive bars 22 connect all of the annular elements electrically. The interconnected assembly of annular elements and bars can be lowered as the solid pencil ingots melt by hoist apparatus 24, which is connected to the interconnected assembly by structural supports 26. Annular elements 20 may include compressive force elements that compress against the top or outer side surfaces of the pencil ingots to maintain electrical contact with the ingots as they melt.

The electric induction furnace may include a pencil ingot support apparatus for one or more of the pencil ingots. For example in FIG. 7(a) and FIG. 7(b) ingot support annular elements 30 surrounds pencil ingots 90a and 90d and are attached to moveable support elements 32, which in turn are slidably attached to crucible supports 34 so that moveable support elements 32 can be lowered as the pencil ingots melt. With this arrangement annular elements 30 will continue to surround and support the ingot as it is melting. In some examples of the invention the ingot support apparatus and the electrically conductive interconnected assembly can be combined.

While the above examples of the invention describe totally melting the pencil ingots, in other examples of the invention, the discrete charges may be inductively heated and removed from the crucible in a semisolid state for further processing.

In some examples of the invention at least the interior volume of the crucible may be maintained at near vacuum or other controlled environmental state, such as, but not limited to, an inert gas environment.

Although the above examples of the invention illustrate electric induction heating of four pencil ingots or other discrete electrically conductive charges, any other number of discrete electrically conductive charges may be inductively heated or melted by the process of the present invention. Further the multiple discrete electrically conductive charges may have different dimensions such as height.

The above examples of the invention have been provided merely for the purpose of explanation and are in no way to be construed as limiting of the present invention. While the invention has been described with reference to various embodiments, the words used herein are words of description and illustration, rather than words of limitations. Although the invention has been described herein with reference to particular means, materials and embodiments, the invention is not intended to be limited to the particulars disclosed herein; rather, the invention extends to all functionally equivalent structures, methods and uses. Those skilled in the art, having the benefit of the teachings of this specification, may effect numerous modifications thereto, and changes may be made without departing from the scope of the invention in its aspects.

1. A method of heating or melting a plurality of discrete electrically conductive charges in an electric induction furnace, the method comprising the steps of:
loading the plurality of discrete electrically conductive charges into a crucible;
forming an electrically conductive path between each one of the plurality of discrete electrically conductive charges; and
supplying alternating current to at least one induction coil surrounding the exterior of the crucible to generate at least one electromagnetic magnetic field for magnetic flux coupling with at least one of the plurality of discrete electrically conductive charges.

2. The method of claim 1 wherein the step of forming an electrically conductive path between each one of the plurality of discrete electrically conductive charges comprises connecting discrete electrical conducting elements between each of the plurality of discrete electrically conductive charges disposed along the length of each of the electrically conductive charges.

3. The method of claim 1 wherein the step of forming an electrically conductive path between each one of the plurality of discrete electrically conductive charges comprises maintaining a heel of an electrically conductive material in the crucible prior to the step of loading the plurality of discrete electrically conductive charges into the crucible.

4. The method of claim 1 wherein the step of forming an electrically conductive path between each one of the plurality of discrete electrically conductive charges comprises depositing a volume of an electrically conductive material in the crucible subsequent to the step of loading the plurality of discrete electrically conductive charges into the crucible.

5. The method of claim 1 further comprising the step of establishing a controlled environment at least within the interior volume of the crucible during the heating or melting of the plurality of discrete electrically conductive charges in the crucible.

6. The method of claim 1 further comprising the step of withdrawing one or more of the plurality of discrete electrically conductive charges from the crucible in a heated semisolid state.

7. A method of heating or melting a plurality of pencil ingots in an electric induction furnace, the method comprising the steps of:
loading the plurality of pencil ingots into a crucible;
forming an electrically conductive path between each one of the plurality of pencil ingots; and
supplying alternating current to at least one induction coil surrounding the exterior of the crucible to generate at least one electromagnetic magnetic field for magnetic flux coupling with the plurality of pencil ingots.

8. The method of claim 7 wherein the step of forming an electrically conductive path between each one of the plurality of pencil ingots comprises connecting discrete electrical conducting elements between each of the pencil ingots disposed along the length of each of the electrically conductive charges.

9. The method of claim 7 wherein the step of forming an electrically conductive path between each one of the plurality of pencil ingots comprises maintaining a heel of an electrically conductive material in the crucible prior to the step of loading the plurality of pencil ingots into the crucible, the heel having a height in the crucible of at least ten percent of the length of the longest one of the plurality of pencil ingots in the crucible.

10. The method of claim 7 wherein the step of forming an electrically conductive path between each one of the plurality of pencil ingots comprises depositing a volume of an electrically conductive material in the crucible subsequent to the step of loading the plurality of discrete electrically conductive charges into the crucible, the volume of the electrically conductive material having a height of at least ten percent of the length of the longest pencil ingot of the plurality of pencil ingots.

11. The method of claim 7 further comprising the step of establishing a controlled environment at least within the interior volume of the crucible during the heating or melting of the plurality of pencil ingots in the crucible.

12. The method of claim 7 further comprising the step of withdrawing one or more of the plurality of pencil ingots from the crucible in a heated semisolid state.

13. An apparatus for inductively heating or melting a plurality of electrically conductive charges, the apparatus comprising:
a crucible for containing the plurality of discrete electrically conductive charges;
at least one induction coil surrounding the exterior of the crucible;
at least one source of alternating current connected to the at least one induction coil; and
an electrically conductive interconnecting charge assembly for electrically interconnecting all of the plurality of electrically conductive charges.

14. The apparatus of claim 13 wherein the electrically conductive interconnecting charge assembly is moveably mounted within the crucible to maintain electrical contact with the plurality of electrically conductive charges during inductive heating or melting within the crucible.

15. The apparatus of claim 13 further comprising a charge holding apparatus for holding at least one of the plurality of electrically conductive charges in place during inductive heating or melting of the at least one of the electrically conductive charges in the crucible.

16. The apparatus of claim 13 wherein the charge holding apparatus is moveably mounted within the crucible to hold the at least one of the plurality of electrically conductive charges in place during inductive heating or melting within the crucible.
